(19) United States
(12) Patent Application Publication
(10) Pub. No.: US 2025/0258516 A1
(43) Pub. Date: Aug. 14, 2025

(54) Hardware Timer Manager Supporting Multiple Precision Levels

(71) Applicant: TEXAS INSTRUMENTS INCORPORATED, Dallas, TX (US)

(72) Inventors: Joseph Aronson, Dallas, TX (US); Denis R. Beaudoin, Rowlett, TX (US)

(21) Appl. No.: 18/902,329

(22) Filed: Sep. 30, 2024

Related U.S. Application Data
(60) Provisional application No. 63/553,182, filed on Feb. 14, 2024.

(51) Int. Cl. G06F 1/04

(52) U.S. Cl. CPC G06F 1/04

(57) ABSTRACT

A hardware timer manager may be employed in a network accelerator. The timer manager may support multiple precision levels of timers. A timer manager may split up a total group of supported timer entries into multiple precision groups in a memory. The timer manager may check a programmed number of timer entries in a highest precision group before checking a single programmed timer entry in the next group, and repeating this checking scheme until a timer entry in a lowest precision group is checked, then repeating it from the start.

### CROSS-REFERENCE TO RELATED APPLICATIONS

The present application claims the benefit of U.S. Provisional Patent Application 63/553,182, filed Feb. 14, 2024, the disclosure of which is hereby incorporated by reference in its entirety.

### TECHNICAL FIELD

The present disclosure relates generally to timer managers and, more specifically, to timer managers configured to support multiple precision levels for timers.

### BACKGROUND

In a digital system, it is useful to track time of data and tasks in, out, and/or throughout the system. This may be referred to as timestamping and may be beneficial to synchronize the reference time used across multiple connected systems so that they operate with the same point of reference. Programming timers to expire in a set period of time may also be useful. Timers may be used to schedule future tasks and work and set timeouts for functions.

For software and firmware, it may be helpful to have a timer manager handle the timestamp and timer functionality as well as to provide a straightforward interface for users to interact with. Some timer managers may be costly depending on the number of timers they track, the time precision level, witch timestamping and timer ranges and features are supported, and how the timer manager provides an event when a timer expires.

### SUMMARY

In an arrangement, a method includes: determining a number of timer entries in a first group of timer entries; accessing a first subset of the first group of timer entries containing the number of timer entries; determining whether any of the first subset of the first group of timer entries corresponds to a timer expiration; and after the accessing of the first subset of the first group of timer entries: accessing a timer entry of a second group of timer entries; and determining whether the timer entry of the second group of timer entries corresponds to a timer expiration; and after the accessing of the timer entry of the second group of timer entries: accessing a second subset of the first group of timer entries containing the number of timer entries; and determining whether any of the second subset of the first group of timer entries corresponds to a timer expiration.

In an arrangement, a network accelerator includes: a processor core; a processor scheduler, communicatively coupled with the processor core; and a timer manager, communicatively coupled with the processor scheduler, wherein the timer manager includes: a memory configured to store a plurality of timer entries that includes a first group of timer entries and a second group of timer entries; a plurality of registers configured to store first settings of a first group of the timer entries and to store second settings of a second group of the timer entries; and hardware logic configured to determine whether the first group of timer entries corresponds to a timer expiration more often than the second group of timer entries, according to the first settings and the second settings, and further configured to communicate with the processor core via the processor scheduler in response to accessing the plurality of timer entries.

In an arrangement, a hardware timer manager includes: a memory RAM configured to store a plurality of timer entries; a plurality of registers configured to store an indication of a first precision level for a first group of the timer entries and to store an indication of a second precision level for a second group of the timer entries; and hardware logic configured to determine whether the first group of timer entries corresponds to a timer expiration based on the first precision level and to determine whether the second group of timer entries corresponds to a timer expiration based on the second precision level, further wherein the first precision level is different from the second precision level.

### BRIEF DESCRIPTION OF THE DRAWINGS

Having thus described the invention in general terms, reference will now be made to the accompanying drawings, wherein:

FIG. 1 is an illustration of an example timer manager, adapted according to some embodiments.

FIG. 2 is an illustration of format of a timer entry within timer RAM, according to some embodiments.

FIG. 3 is an illustration of an example method, for managing multiple timer entry groups to provide multiple precision levels, according to some embodiments.

FIG. 4 is an illustration of an example method, for managing groups of timer entries, according to some embodiments.

FIG. 5 is an illustration of an example network accelerator, which may include a timer manager (e.g., the timer manager of FIG. 1), according to some embodiments.

FIG. 6 is an illustration of an example system on-chip (SoC), which may include the example network accelerator of FIG. 5, according to some embodiments.

### DETAILED DESCRIPTION

The present disclosure provides a timer manager that supports multiple precision levels, automatic expiration event scheduling, and timestamp with synchronization capability.

The multiple precision levels allow for high and low precision timers while maintaining small design cost. In some examples, a timer manager works by splitting up the total supported timers into precision groups, checking a programmed number of timers in a highest precision group before checking one in the next group, and repeating this checking scheme until a lowest precision group is checked, then repeating it from the start. This supports a range of timer expiration periods while not giving up precision.

In some examples, the timer manager provides an event upon a timer expiration by scheduling an event directly to a processor core connected in the system. This may be done automatically after a timer has expired when checked. The timer manager pushes the event to a hardware queue in order to support buffering of multiple timer events when the processor core is unable to service them in time.

In some examples, the timer manager supports a timestamping counter with a software interface to synchronize it with other timestamps in the system. The counter may be programmed directly, nudged by an 8-bit signed value (adjust once), incremented or decremented periodically (adjust for skew), and incremented by one or more each clock.

The timer manager's software interface may be used to add or modify timer entries. To add a timer, the user (e.g., a processor core) may program each timer field including which precision group the timer belongs to. At any time thereafter, the user may read the timer's status (whether it was added successfully) and index in order to track it. The user may set whether the new timer is a single or periodic timer. If periodic, the timer manager may automatically re-arm the timer after expiration with a new expiration value based on its programmed period. To delete a timer, the user may program the index of the desired timer to delete. This quick access provides more bandwidth to the user and allows dynamic addition and deletion of timers for applications such as setting and removing a timeout function in case the task was successfully completed before timeout occurred.

While no particular advantage is required for any particular embodiment, in some examples, the timer manger's multiple precision groups may enable a wide range of timer precision levels and expiration periods while maintaining a small design cost. The timestamping functionality with synchronization may be valuable for time-sensitive networking (TSN) as well as other networking and software applications. The direct event scheduling may be advantageous for systems and software that are heavily event-driven. In these examples and others, the software interface may provide all the necessary functionality while maintaining minimal accesses that allow for more user bandwidth.

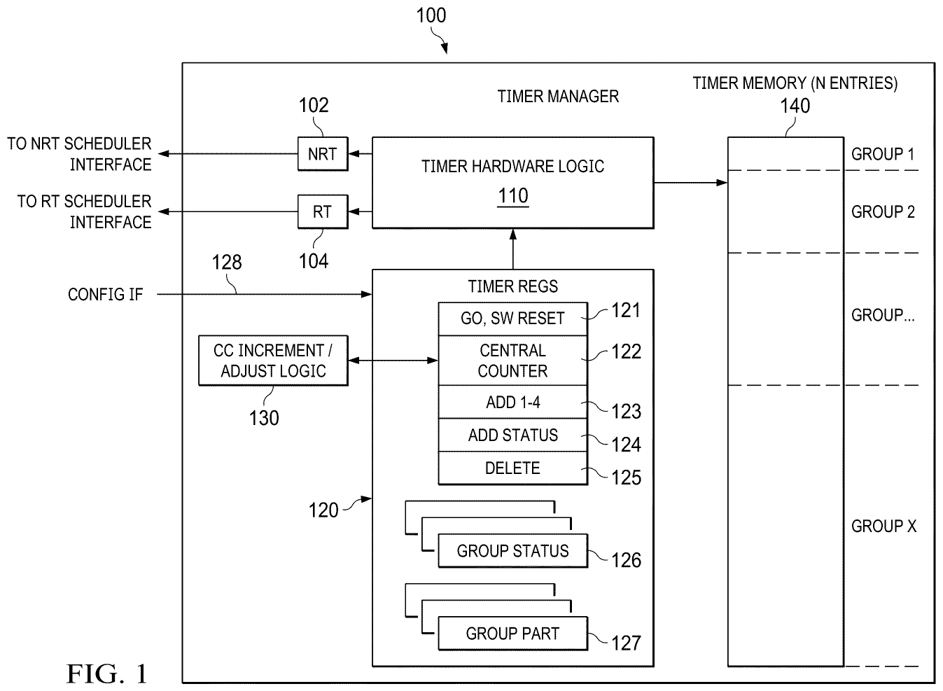

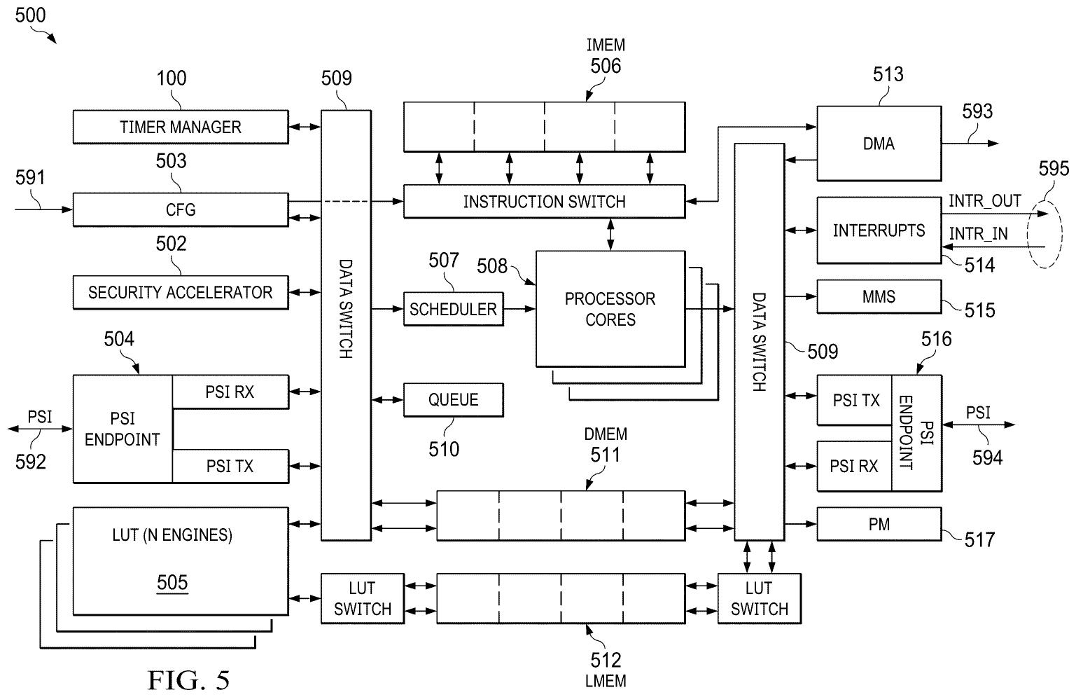

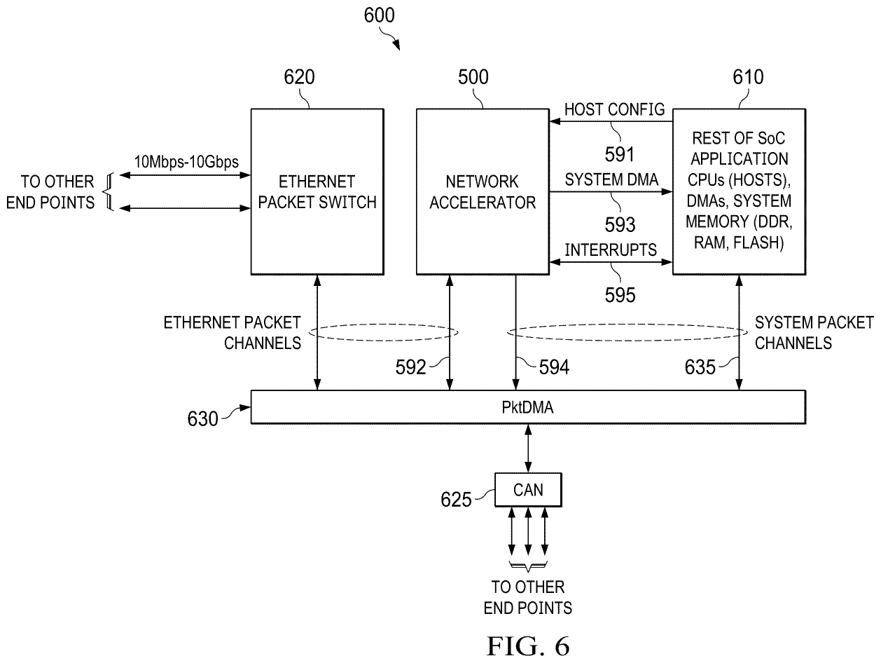

FIG. 1 is an illustration of an example timer manager 100, adapted according to some embodiments. Timer manager 100 may be implemented in any appropriate manner, such as in a network accelerator, which itself is implemented within the circuitry of a system on-chip (SoC). An example of a network accelerator includes network accelerator 500 of FIG. 5, and an example SoC includes SoC 600 of FIG. 6. FIGS. 5 and 6 are described in more detail below.

Timer manager 100 includes timer registers 120, timer memory (e.g., RAM) 140, timer hardware logic 110, central counter adjustment logic 130, non-real-time first-in-first-out (FIFO) buffer 102, and real time (RT) FIFO buffer 104. In this example, a processor core (not shown, such as in a network accelerator or an SoC) may configure a timer using the configuration interface 128 to write data into the timer registers 120. In response, the timer hardware logic 110 may add a timer entry into an appropriate group in timer memory 140. The central counter 122 may be a counter register or other appropriate data structure, which either increments or decrements based on cycles of a clock (not shown).

The timer hardware logic 110 accesses the timer entries in timer memory 140 to determine expiration. For instance, a given timer entry may include an expiration value indicating its expiration, and the timer hardware logic 110 may compare the expiration value against a current value of central counter 122 to determine whether the timer entry has expired. If the timer entry has expired, the timer hardware logic 110 may take an action in response to the expiration. One such action includes adjusting the expiration value in response to determining that the timer entry indicates it is a periodic timer entry. Another such action includes writing a processor function pointer and a processor function argument from the timer entry to either the non-real-time FIFO buffer 102 or the real-time FIFO buffer 104. For instance, some timer entries may include data indicating a real-time status or may include data indicating a non-real-time status, and the timer hardware logic 110 may use that data to write to either the FIFO buffer 102 of the FIFO buffer 104 in response to that status data.

The FIFO buffer 102 may provide data to a non-real-time scheduler interface, and the FIFO buffer 104 may provided data to a real-time scheduler interface. Each of the scheduler interfaces may be included in a processor scheduler (e.g., scheduler 507 of FIG. 5), which receives function pointers and arguments and provides orderly arbitration as it provides those function pointers and arguments to a processor (e.g., one of processor cores 508 of FIG. 5). For instance, the scheduler may treat real-time events with a higher priority than non-real-time events. In this way, the processor core may execute a function, based on the function pointer and the function argument, in response to a timer expiring.

The timer registers 120 may act as a software interface for a processor core. For instance, some or all of the timer registers 121 and 123-127 may be configured as memory mapped registers (MMRs) in an address space of one or more processor cores (not shown). Examples of processor cores that may write to or read from the timer registers 120 include an application processor core (such as in 610 of FIG. 6) and an accelerator processor core (such as one of processor cores 508 of FIG. 5).

As noted above, an individual timer entry may be part of a particular group of timer entries, and each of those groups may correspond to a respective precision level. A processor core may configure a timer group by writing to the group status registers 126 and the group part registers 127. In one example, the group part registers 127 may include data indicating timer indices that start each of the groups. In an example in which the timer memory 140 may accommodate 128 (0-127) timer entries, Group 1 may begin at index 0, Group 2 may begin at index 20, and on and on until Group x may begin at index 63 and end at index 127. Of course, those are just examples, and the scope of implementations may include any appropriate number of timer entries and any appropriate grouping of timer entries.

The group part registers 127 may also include data indicating a number of timer entries to check in a group before checking a single entry in the next group. This concept is explained in more detail below, and it configures the precision levels. In other words, some groups may be checked at different frequencies than other groups, and the groups that are checked at higher frequencies are the higher precision groups, and the groups that are checked at lower frequencies are the lower precision groups.

In one example, a particular timer group may be disabled by a processor core that writes its start index to a total number of timer entries (e.g., 128) and sets a number of checks to zero.

The group status registers 126 may be written to and read from by the timer hardware logic 110. The group status registers 126 may include data indicating whether a particular group is full or not full, a first free index of a group, and a next timer index to check in a group. The timer hardware logic 110 may read and, when appropriate, update the data in the group status registers 126 as groups become full or not full, new timer entries are written or existing timer entries are deleted, and as a timer check progresses through a set of indices.

Register 121 includes go data and software reset data, either of which data may be represented as a single bit or multiple bits. For instance, a processor core may write a zero or one to cause a software reset of the timer entries in timer memory 140. The processor core may also write a zero or a one to instruct the timer hardware logic 110 to either stop or start checking the timer entries in timer memory 140 (go data). The timer hardware logic 110 may read a value from register 121 and then perform a corresponding action.

Although not shown in FIG. 1, timer registers 120 may also include one or more registers configured to store an ID of an initiator. For instance, a processor core that writes to the timer registers 120 may also write its processor ID to a register.

Central counter 122 may count up (increment) or count down (decrement) according to a system clock (not shown). In one example, the central counter 122 may include 56 bits indicating a value that is incremented with each clock cycle and rolls over to all zeros after reaching a value of all ones. Timer manager 100 further includes central counter increment and adjustment logic 130, which may adjust a value of the central counter 122 under control of either a processor core (e.g., 508 or 610) or the timer hardware logic 110. Examples of control by the logic 130 may include: a value for incrementing the counter value per clock cycle, a one-time addition of a fixed eight-bit signed value to increase or decrease the counter value, a periodically repeating addition or subtraction to the most significant bits of the counter value, and a periodically repeating addition or subtraction to the least significant bits of the counter value. Of course, the scope of implementations may include any appropriate adjustment of the counter value and any number of bits for central counter 122.

Register 123 may be configured to include data to add a new timer entry to one of the groups in timer memory 140. For instance, data that may be written by a processor core to register 123 may include: a group to which to add the new timer entry, RT or NRT status of the new timer entry, single iteration or periodic iteration status of the timer entry, a processor function pointer associated with the new timer entry, a processor function argument associated with the new timer entry, and the like. During an addition operation, a processor core may write to register 123, and the timer hardware logic 110 may read the data from register 123 and set an appropriate timer entry in an appropriate group within timer memory 140. The timer hardware logic 110 may assign an index to the timer entry and then write that index to register 124, where the index placement in the register 124 indicates successful addition of the timer entry. The timer hardware logic 110 may indicate the index to the processor core. The processor core may read the index from the register 124 to track the timer entry and also to determine that the timer entry has been successfully added.

Also, memory space for a particular group is finite, and in some instances a group may be full. Should a particular group be full, then timer hardware logic 110 may write that a particular group is full to register 124, thereby indicating that a processor core may create a new timer in that group.

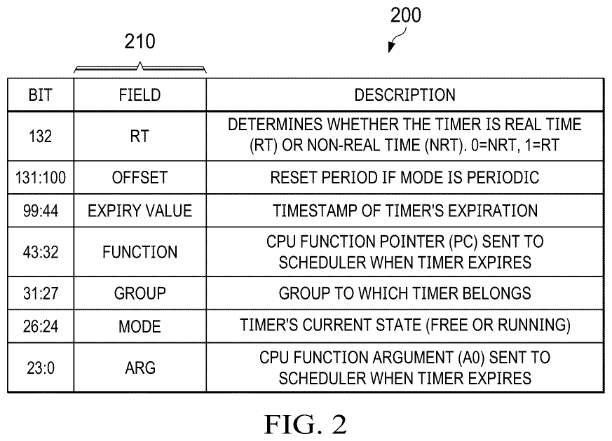

Register 125 may be configured to store data associated with deleting an existing timer entry. For instance, a processor core may cause a timer entry to be deleted by writing the index of that timer to the register 125. The timer hardware logic 110 may then read the value from the register 125 and delete the corresponding timer entry. In one example, the timer hardware logic 110 may delete the timer entry by changing a mode of an entry to a free value, which is discussed in more detail with respect to FIG. 2.

FIG. 2 is an illustration of an example format of a timer entry 200 within timer memory 140, according to some embodiments. In some examples, each of the groups may span a certain address range within timer memory 140, and each given timer entry in a group may be placed within that address range. In one further example, each timer entry may occupy a word within a range of addresses for its group. Also, the address ranges of the groups may be physically adjacent and/or logically adjacent within timer memory 140. For instance, the last word in the address range of Group 1 may be adjacent to the first word in Group 2, and on and on. That may be true physically in some instances. In other instances, the address ranges may be logical, and the logical addresses of each group may be adjacent, whether or not they are physically adjacent.

In the example of FIG. 2, timer entry 200 includes a 133-bit word written to timer memory 140. The timer entry 200 includes fields 210, which may be written by timer hardware logic 110 and may be based upon data written by a processor core to the registers 123-124.

The field RT indicates a priority of the timer entry, for example, whether the timer entry is real-time or non-real-time. The field Offset indicates a value to be added to a timer expiry value, upon expiration of that timer entry, in the case that the timer entry is a periodic timer entry to indicate the end of the next period of the timer. The field Expiry Value indicates when the time interval associated with the associated timer is to expire. In some examples, the Expiry Value field specifies a corresponding value of central counter 122 at which the timer entry expires. The field Function is a processor pointer, which is configured to be sent to the scheduler (via one of FIFO buffers 102, 104) upon expiration of the timer entry and which may specify a processor operation and/or code to be executed by the associated processor core. The field Group indicates which of the groups the timer entry belongs to.

The field Mode indicates a timer entry's current state, such as free or running and periodic or single. For instance, a value of zero may indicate that the timer entry is free (e.g., ready to be written to for use as a new timer), such as may be set by deletion of the timer entry. On the other hand, if the timer is currently running, then the Mode value may be a non-zero value indicating whether the timer entry is a periodic iteration entry or a single iteration entry. As noted above, a timer entry that is periodic may have its expiry value modified by a value in the Offset field when the timer is determined to be expired. A timer entry that is single iteration may be deleted after it is determined to be expired. The expiry of a timer may be accompanied by the timer hardware logic 110 transmitting the values from the Function and Arg fields to the scheduler via one of the FIFO buffers 102, 104.

The field Arg is a processor function argument that goes along with the function pointer of the Function field. In one example, a function pointer may correspond to a particular processing operation, and the Arg value may represent a data memory address of a packet to be processed by the operation, though the scope of implementations may include any appropriate function and argument.

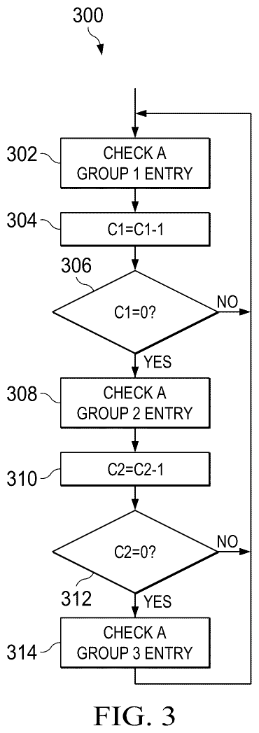

FIG. 3 is an illustration of example method 300, for managing multiple timer entry groups to provide multiple precision levels, according to some embodiments. Method 300 may be performed, e.g., by a timer manager, such as timer manager 100 having timer hardware logic 110. The groups, Group 1-Group 3, in this example may refer to groups of timer entries, such as may be stored in timer memory 140 and configured using data in registers 126-127.

Further in this example, C1 refers to a number of checks in Group 1 before a single check is made of a timer entry in Group 2; C2 refers to a number of checks in Group 2 before a single check is made of a timer entry in Group 3. While the example of FIG. 3 includes three groups, it is understood that various embodiments may scale the number of groups as appropriate. For instance, to expand from three groups to four groups, an embodiment may include a number C3 which refers to a number of checks in Group 3 before a single check is made of a timer entry in Group 4. In the example of FIG. 1, the values C1-C3 may be stored in register 127 and may be configured through the configuration interface 128 by an application processor core.

At action 302, the timer manager checks a Group 1 entry. For instance, the timer hardware logic 110 may compare an expiry value in a first timer entry in Group 1 to a current value of central counter 122. In one example, the timer entry is expired if the current value of the central counter 122 exceeds the expiry value and does so by less than half of the central counter's maximum value, taking rollover into account, otherwise, the timer entry has not expired. Of course, expiration can be defined in any appropriate manner. Since there may not be C1 active timer entries in Group 1, the timer manager check at action 302 may include checking whether the respective timer entry is active.

Action 304 includes decrementing C1 by a value of one, and action 306 includes determining whether C1 has reached zero. If C1 has not yet reached zero, then method 300 loops back to action 302. In other words, method 300 includes performing an integer number C1 of checks of entries within Group 1 before checking a single entry of Group 2 at action 308. At action 310, C2 is decremented by a value of one. At action 312, the timer hardware logic 110 checks whether C2 has reached zero. If C2 has not yet reached zero, then method 300 loops back to action 302. If C2 has reached zero, then method 300 goes to action 314 to check a single entry of Group 3. After checking the single entry of Group 3, method 300 loops back to action 302.

Although not specifically shown in FIG. 3, the loop of actions 302-306 may include progressing from an address of a first timer entry to an address of a next timer entry with each performance of the loop. Therefore, the loop of actions 302-306 may perform a check of C1 individual timer entries within Group 1. Similarly, each check of action 308 may include progressing from an address of a first timer entry of Group 2 to an address of a next timer entry with each performance of action 308. And each time action 314 is performed, it may progress from an address of a first timer entry in Group 3 to an address of a next timer entry. Of course, each group in this example includes a finite quantity of entries, so once an end of an address range of a group is reached, the next check within that group may proceed to the first timer entry of that group.

Moreover in this example, the method 300 may be performed continually for as long as timer manager 100 is powered up and not reset. In other words, when a quantity C1 (or C2 or C3) runs to zero, such quantity may be reinitialized back to the original and maximum quantity C1 (or C2 or C3). In some examples, method 300 may be halted by an application processor core changing a go bit in register 121 or causing a software reset by changing a value in register 121.

One way to understand method 300 is that it includes nested loops. For instance, the inner nested loop represents checks of Group 1 timer entries. The middle loop includes checks of Group 2 timer entries, and the outer loop includes checks of Group 3 timer entries. As a result of the nested loop structure, the timer entries of Group 1 are checked more often than are the timer entries of Group 2, and the timer entries of Group 2 are checked more often than are the timer entries of Group 3. In this example, Group 1 represents a high precision group of timer entries, Group 2 represents a mid-level precision group of timer entries, and Group 3 represents a low precision group of timer entries.

The following is an example use case of method 300, assuming a clock rate of 2 ns, where at each clock cycle the timer hardware logic 110 performs a check of a timer entry, such as in one of actions 302, 308, or 314:
Timer Entry/Group checking algorithm (3 Groups)
   C1=number of checks in Group 1
   C2=number of checks in Group 2
   Check C1 Timer Entries in Group 1, then one in Group 2
   Repeat until C2 Timer Entries in Group 2 have been checked
   Check one in Group 3 (adjacent to Group 2 check)
   Repeat by going back to Group 1
Timer Group precision calculation
   Variable definitions
      period=clock period
      N1=number of Timer Entries in Group 1
      N2=number of Timer Entries in Group 2
      N3=number of Timer Entries in Group 3
      C1=number of checks in Group 1
      C2=number of checks in Group 2
      P1=precision for Group 1
      P2=precision for Group 2
      P3=precision for Group 3
   Precision formulas

$$\begin{matrix}P 1 = period * ( N 1 + ( N 1 / C 1 ) + ( N 1 / ( C 2 * C 1 ) ) ) \\ P 2 = period * ( N 2 + ( N 2 * C 1 ) + ( N 2 / C 2 ) ) \\ P 3 = period * ( N 3 + ( N 3 * C 2 * C 1 ) + ( N 3 * C 2 ) )\end{matrix}$$

Example precision calculation
   period=2 ns
   N1=20
   N2=30
   N3=40
   C1=10
   C2=5

$$\begin{matrix}P 1 = 2 ns * ( 20 + ( 20 / 10 ) + ( 20 / ( 5 * 10 ) ) ) = 44.8 ns \\ P 2 = 2 ns * ( 30 + ( 30 * 10 ) + ( 30 / 5 ) ) = 672 ns \\ P 3 = 2 ns * ( 40 + ( 40 * 5 * 10 ) + ( 4 {0}^{*} 5 ) ) = 4480 ns\end{matrix}$$

Thus, in the example above, each timer entry in Group 1 is checked by the timer hardware logic 110 every 44.8 ns, each timer entry in Group 2 is checked by the timer hardware logic 110 every 672 ns, and each timer entry in Group 3 is checked by the timer hardware logic 110 every 4480 ns. Note that there is more than an order of magnitude difference between the checking frequency of Group 1 entries versus that of Group 2 entries. There is also an order of magnitude difference between the checking frequency of Group 1 entries versus that of Group 3 entries. Of course, the frequency of checking depends on the parameters: clock cycle period, the number of active timer entries in a group (N1-N3), and the values C1 and C2. The parameters N1-N3 may change as timers are added or deleted, and as noted above, C1 and C2 may be configured via configuration interface 128. In some examples, the clock period may or may not be adjustable. The scope of implementations may include configuring the parameters in any appropriate manner.

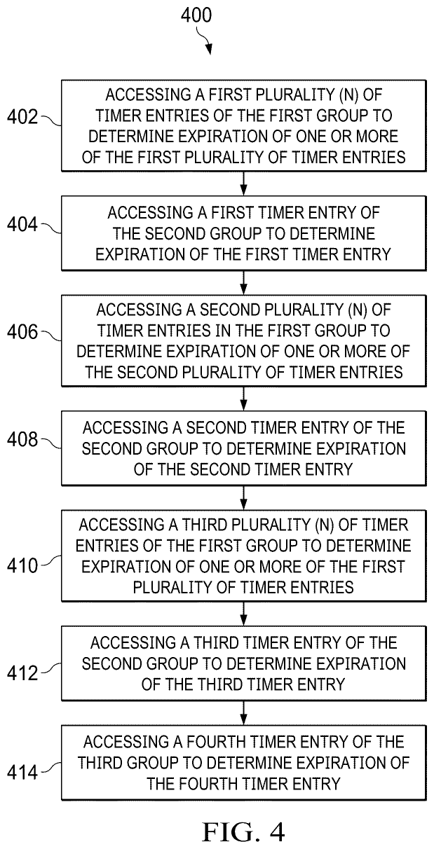

FIG. 4 is an illustration of example method 400, for managing groups of timer entries, according to some embodiments. Method 400 may be performed by a timer manager, such as timer manager 100 of FIG. 1. The example method 400 refers to three precision groups, though it is understood that the scope of implementations may be scaled to as many precision groups as is appropriate.

At action 402, the timer manager accesses a first plurality (N) of timer entries of the first group to determine whether some of the first plurality of timer entries are active and to determine expiration of one or more of the first plurality of the active timer entries. For instance, action 402 may be illustrated by the loop of actions 302-306, where C1 corresponds to the first plurality N. An accessing operation in method 400 may include performing checks of timer entries within the groups, such as by comparing respective expiry values of the active timer entries to a current value of a counter.

Action 402 may further include performing an appropriate action in response to determining that a timer entry has expired. In some examples, a timer entry is expired if the central counter exceeds an expiry value by less than half the central counter's maximum value, accounting for rollover of the counter. Furthermore, for implementations that support both real time (RT) and nonreal time (NRT) timer entries, a given timer entry may be considered not expired if either it is NRT and the NRT FIFO buffer is full or if the timer entry is RT and the RT FIFO buffer is full and a timer entry is not in a highest precision level group. Examples of FIFO buffers include FIFO buffers 102 and 104 of FIG. 1, which receive data from the timer hardware logic 110 and pass that data to an interface of a processor scheduler (e.g., scheduler 507 of FIG. 5).

When a timer entry expires, the timer manager may perform an appropriate expiry action. In one example, the timer manager may push the values from the Function and Arg fields of the expired timer entry to either the RT FIFO buffer or NRT FIFO buffer as appropriate. If an entry is a periodic entry, as determined by the Mode field, then the timer manager may calculate a new expiry value based on the Offset field and the Expiry Value field and then write the new value to the Expiry Value field. If the timer entry is a single timer entry, as determined by the Mode field, then the timer manager may delete the timer entry by changing the Mode field to free.

At action 404, the timer manager accesses a first timer entry of the second group to determine whether the first timer entry is active and to determine expiration of the first timer entry. An example is shown in FIG. 3 in which the timer manager moves from the loop of actions 302-306 to perform the check at action 308. If the check timer entry has expired, then the timer manager may perform an appropriate expiry action, as described above.

At action 406, the timer manager accesses a second plurality (N) of timer entries in the first group to determine whether some of the second plurality of timer entries are active and to determine expiration of any active entries of the second plurality of timer entries. An example is given above with respect to FIG. 3, in which action 312 includes looping back to action 302 after checking a single entry of Group 2. The second plurality of timer entries may or may not be the same individual timer entries as the first plurality of timer entries at action 402. For instance, the number of checks performed in Group 1 at actions 402 and 406 may be different from a number of active timer entries within Group 1. As noted above, some implementations may include checking timer entries index by index (e.g., address by address) incrementing a timer entry index with each check and going back to the first timer entry once all of the active timer entries in the group have been checked. The number of active timer entries in a group may be greater than, less than, or equal to the number of checks performed in a loop.

If a given timer entry in the second plurality has expired, then the timer manager may perform an appropriate expiry action.

At action 408, the timer manager accesses a second timer entry of the second group to determine expiration of the second timer entry. An example is described above with respect to FIG. 3, in which a single timer entry of Group 2 is checked after completion of the inner loop of actions 302-306. If the second timer entry has expired, then the timer manager may perform an appropriate expiry action.

At action 410, the timer manager accesses a third plurality of timer entries of the first group to determine whether some of the third plurality of timer entries are active and to determine expiration of any active entries of the third plurality of timer entries. If a given timer entry of the third plurality of timer entries has expired, then the timer manager may perform an appropriate expiry action. Action 410 illustrates that the checking operation may repeat the loop of actions 302-306 after performing a check of a Group 2 entry.

At action 412, the timer manager accesses a third timer entry of the second group to determine expiration of the third timer entry. If the third timer entry has expired, then the timer manager may perform an appropriate expiry action. Action 412 illustrates that each time the loop of actions 302-306 is performed, then it may progress to a check of a Group 2 timer entry.

Action 414 includes accessing a fourth timer entry of the third group to determine expiration of the fourth timer entry. If the fourth timer entry has expired, then the timer manager may perform an appropriate expiry action. An example of action 414 is illustrated in FIG. 3, in which the timer manager checks only a single timer entry of Group 3 in response to having checked C2 quantity of timer entries of Group 2.

In the example of method 400, the method may continue to be performed, such as by progressing to action 402 in response to having completed action 414.

FIG. 5 is an illustration of an example network accelerator 500, which may include a timer manager (e.g., timer manager 100 of FIG. 1), according to some embodiments. The example network accelerator 500 may be implemented within a system on-chip (SoC) such as example SoC 600 of FIG. 6.

When implemented in systems, such as network accelerator 500 and SoC 600, timer manager 100 may provide multiple timer groups, each of the groups having a different precision level. An example of a lower precision operation, which may be facilitated by a lower-precision timer group (e.g., Group 3 of FIG. 3) includes a transport control protocol (TCP) retransmit timer. For instance, the network accelerator 500 may transmit a TCP packet and then initialize a timer entry with a conservative arrival time of an acknowledgment packet (e.g., on the order of seconds). If the network accelerator 500 determines that the acknowledgment packet is received before determining that the timer entry has expired, then the network accelerator 500 may cause the timer manager to delete the timer entry. However, if the network accelerator 500 determines that the acknowledgment packet has not been received after having determined that the timer entry has expired, then the network accelerator 500 may perform a TCP retransmission.

In an example of a mid-level precision operation, the network accelerator 500 may perform audio-video bridging (AVB). In an example AVB operation, AVB packets are sent at regular intervals and allocated time slots to guarantee a particular latency. An example latency may be 2 ms for class A traffic and 50 ms for class B traffic. The network accelerator 500 may cause the timer manager to set a first periodic timer entry for 2 ms and set a second periodic timer entry for 50 ms. The first periodic timer entry may include an Offset field corresponding to 2 ms, a Function field corresponding to a packet transmit, and an Arg field pointing to an address of class A packets. Similarly, the second periodic timer entry may include an Offset field corresponding to 50 ms, a Function field corresponding to a packet transmit operation, and an Arg field pointing to an address of class B packets.

In an example of a high precision operation, the timer manager may facilitate time synchronization for time-sensitive networking (TSN). The high precision operation may be on the order of nano-seconds. For instance, the network accelerator 500 may include a first port, and another network accelerator, perhaps in another SoC, may include a second port. The network accelerator 500 may use its timer manager to synchronize timestamps from the first port to the second port. Such operation may include receiving a packet having a timestamp from the other network accelerator at the first port of the first network accelerator as well as sending a packet having a timestamp from the network accelerator 500 to the second port of the other network accelerator. A processor core of the network accelerator 500 may perform such sending and receiving of timestamped packets to eventually create synchronization.

Some embodiments may provide advantages over other embodiments. For instance, the timer manager discussed herein, may provide multiple precision levels by checking different groups using different frequencies of checking. By contrast, other systems may include a timer manager that checks all of its timer entries at a same frequency, thereby wasting some logic resources by providing a higher frequency of checking than is appropriate for some lower-frequency operations. The timer manager of FIG. 1 may be implemented using hardware appropriate to provide a desired number of groups and a desired precision level for the groups, thereby allowing for more efficient use of logic. More efficient use of logic may lead to a lower number of transistors to implement that logic, thereby saving semiconductor area.

Furthermore, the example timer manager 100 of FIG. 1 may include registers 123-127 to allow for groups to be configured and to allow for individual timer entries to be configured. Such registers may be accessible by an application processor core of the SoC 600 outside of the network accelerator 500 and may also be accessible by one or more processor cores of the network accelerator 500. The processor cores may read and write to the registers 123-127 to communicate with the timer manager 100, thereby configuring groups and timer entries. The availability of registers 123-127 to processor cores may allow flexibility and efficiency in configuring groups and timer entries.

Continuing with FIG. 5, network accelerator 500 includes a plurality of processor cores 508, which may include any appropriate processor cores, whether general purpose or otherwise and having any size instruction set. In one example, each of the processor cores 508 execute firmware to provide processing functionality for network accelerator 500. For instance, as noted above, timer manager 100 may perform an expiry action that includes transmitting a function indication and an argument to the scheduler 507. Scheduler 507 may then pass that function indication and argument to one of the processor cores 508. Furthermore, the processor cores 508 may include functionality to configure registers 120. Processor cores 508 may fetch instructions from instruction memory 506 or receive instruction pointers from direct memory access (DMA) interface 513 via bus 593.

An application processor core (e.g., in 610) may offload network functions to the network accelerator 500 so that the application processor core does not have to perform those functions itself. Configuration interface 503 allows for an application processor core to communicate with any of the components of network accelerator 500. For instance, an application processor core may communicate via bus 591, and such communication may write to registers 120 and/or may cause an instruction to be transmitted to one of the processor cores 508.

Security accelerator 502 may perform security functions on behalf of the processor cores 508. For instance, some types of packets (e.g., ethernet packets) may be designated as un-trusted. In such an example, the processor cores 508 may cause such packets to be indicated as either secure or not secure by security accelerator 502 before further processing.

Packet switch interface (PSI) end points 504 and 516 may receive packets and transmit packets into and out of the network accelerator 500 via buses 592 and 594, respectively. Upon receiving a packet, a PSI endpoint 504, 516 may coordinate with memory manager (MMS) 515 to cause space to be allocated within the data memory 511. Once space in the data memory 511 is allocated, the PSI endpoint 504, 516 may then store that packet to the data memory 511 in the allocated address range.

Network accelerator 500 includes two PSI endpoints 504, 516 for increased bandwidth, where PSI endpoint 504 is dedicated for ethernet use, and PSI endpoint 516 is dedicated to other packet protocols. Nevertheless, various embodiments may be adapted for either more or fewer PSI endpoints as appropriate.

An application processor core may configure actions to be taken for particular packets in some examples by writing to lookup table entries in lookup table memory 512. When a packet is received and ready for processing, a processor core 508 may cause one of the lookup table engines 505 to perform a lookup table operation within the lookup table entries in lookup table memory 512. A lookup table operation may result in subsequent actions, such as events being sent to scheduler 507 by a lookup table engine 505, where such event may cause an action by a processor core 508.

Queue manager 510 may be used by the processor cores 508 to manage queues in some examples.

The larger system in which network accelerator 500 is implemented (e.g., SOC 600) may transmit interrupts to the processor cores 508 via interrupt interface 514 and buses 595.

Priority manager 517 is implemented to prioritize some packets over other packets, based on configuration data from an application processor core. For instance, some packets may include data indicating a priority level, and the priority manager 517 may perform priority functions, such as enforcing an order of data memory allocation for packets based on priority levels of the packets.

The various components are communicatively coupled within network accelerator 500 by data switches 509.

FIG. 6 is an illustration of an example SOC 600, according to some embodiments. Network accelerator 500 may be implemented on the SOC 600, though the scope of implementations may include network accelerator 500 being implemented in any appropriate system for offload of network functions by any appropriate processor core.

In the present example, ethernet packets may be received by the ethernet packet switch 620. Packets of other protocols, such as control area network (CAN), may be received by packet switch 625. However, the scope of implementations may include more packet switches or fewer packet switches to handle more or fewer communication protocols as appropriate.

Continuing with a packet receive operation, the packets from packet switches 620, 625 are then transmitted to packet direct memory access 630, which in this example, formats the various packets into one or more formats that are efficient for processing by network accelerator 500. Once the packet DMA 630 has formatted the packets, packet DMA 630 may transmit the packets to the network accelerator 500 via buses 592, 594. Packet direct memory access 630 may communicate with the rest of the SOC 610 through system packet channels 635.

As noted above, the network accelerator 500 may perform network functions on the packets, which allows network functions to be offloaded from the rest of the SOC 610. Examples of operations that the network accelerator 500 may perform include, but are not limited to, reformatting a packet from one protocol to another (e.g., ethernet to CAN or vice versa), dropping a packet, forwarding a packet to a different endpoint, sending payload data from a packet to a component of the rest of the SOC 610, and the like. For an outgoing packet, the network accelerator 500 may transmit such packet to the packet DMA 630 via one of buses 592, 594 to either ethernet packet switch 620 or packet switch 625. The network accelerator 500 may also transmit the payload data from the packet to the rest of the SOC 610 via bus 593.

The rest of the SOC 610 may be configured as appropriate. For instance, the rest of the SOC 610 may include one or more processor cores (e.g., application processor cores, digital signal processing cores, and the like) system memory, memory interfaces or accelerators, and the like.

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Corresponding numerals and symbols in the different figures generally refer to corresponding parts, unless otherwise indicated. The figures are not necessarily drawn to scale. In the drawings, like reference numerals refer to like elements throughout, and the various features are not necessarily drawn to scale. In the following discussion and in the claims, the terms “including,” “includes,” “having,” “has,” “with,” or variants thereof are intended to be inclusive in a manner similar to the term “comprising,” and thus should be interpreted to mean “including, but not limited to . . . ” Also, the terms “coupled,” “couple,” and/or or “couples” is/are intended to include indirect or direct electrical or mechanical connection or combinations thereof. For example, if a first device couples to or is electrically coupled with a second device that connection may be through a direct electrical connection, or through an indirect electrical connection via one or more intervening devices and/or connections. Elements that are electrically connected with intervening wires or other conductors are considered to be coupled. Terms such as “top,” “bottom,” “front,” “back,” “over,” “above,” “under,” “below,” and such, may be used in this disclosure. These terms should not be construed as limiting the position or orientation of a structure or element but should be used to provide spatial relationship between structures or elements.

The term “semiconductor die” is used herein. A semiconductor device can be a discrete semiconductor device such as a bipolar transistor, a few discrete devices such as a pair of power FET switches fabricated together on a single semiconductor die, or a semiconductor die can be an integrated circuit with multiple semiconductor devices such as the multiple capacitors in an A/D converter. The semiconductor device can include passive devices such as resistors, inductors, filters, sensors, or active devices such as transistors. The semiconductor device can be an integrated circuit with hundreds or thousands of transistors coupled to form a functional circuit, for example a microprocessor or memory device. The semiconductor device may also be referred to herein as a semiconductor device or an integrated circuit (IC) die.

The term “semiconductor package” is used herein. A semiconductor package has at least one semiconductor die electrically coupled to terminals and has a package body that protects and covers the semiconductor die. In some arrangements, multiple semiconductor dies can be packaged together. For example, a power metal oxide semiconductor (MOS) field effect transistor (FET) semiconductor device and a second semiconductor device (such as a gate driver die, or a controller die) can be packaged together to from a single packaged electronic device. Additional components such as passive components, such as capacitors, resistors, and inductors or coils, can be included in the packaged electronic device. The semiconductor die is mounted with a package substrate that provides conductive leads. A portion of the conductive leads form the terminals for the packaged device. In wire bonded integrated circuit packages, bond wires couple conductive leads of a package substrate to bond pads on the semiconductor die. The semiconductor die can be mounted to the package substrate with a device side surface facing away from the substrate and a backside surface facing and mounted to a die pad of the package substrate. The semiconductor package can have a package body formed by a thermoset epoxy resin mold compound in a molding process, or by the use of epoxy, plastics, or resins that are liquid at room temperature and are subsequently cured. The package body may provide a hermetic package for the packaged device. The package body may be formed in a mold using an encapsulation process, however, a portion of the leads of the package substrate are not covered during encapsulation, these exposed lead portions form the terminals for the semiconductor package. The semiconductor package may also be referred to as a “integrated circuit package,” a “microelectronic device package,” or a “semiconductor device package.”

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims. Thus, the breadth and scope of the present invention should not be limited by any of the examples described above. Rather, the scope of the disclosure should be defined in accordance with the following claims and their equivalents.

What is claimed is:

1. A method comprising:
determining a number of timer entries in a first group of timer entries;
accessing a first subset of the first group of timer entries containing the number of timer entries;
determining whether any of the first subset of the first group of timer entries corresponds to a timer expiration; and
after the accessing of the first subset of the first group of timer entries:
accessing a timer entry of a second group of timer entries; and
determining whether the timer entry of the second group of timer entries corresponds to a timer expiration; and
after the accessing of the timer entry of the second group of timer entries:
accessing a second subset of the first group of timer entries containing the number of timer entries; and
determining whether any of the second subset of the first group of timer entries corresponds to a timer expiration.

2. The method of claim 1, wherein:
the number of timer entries is a first number of timer entries; and
the method further comprises:
determining a second number of timer entries in the second group of timer entries; and
accessing a subset of the second group of timer entries that contains the second number of timer entries between each access of a third group of timer entries.

3. The method of claim 2, further comprising:
receiving an instruction from an application processor core that specifies the first number of timer entries and the second number of timer entries.

4. The method of claim 3, further comprising:
resetting the first number of timer entries and the second number of timer entries in response to an instruction from an application processor core.

5. The method of claim 1 further comprising:
storing the timer entries of the first group of timer entries to first respective address ranges within a memory and storing the timer entries of the second group of timer entries to second respective address range within the memory.

6. The method of claim 1, wherein determining whether a given timer entry of either the first group of timer entries or the second group of timer entries corresponds to a timer expiration comprises:
comparing a first value, stored within the given timer entry, to a value of a counter; and
determining whether the given timer entry corresponds to a timer expiration based upon the comparing.

7. The method of claim 6, further comprising:
in response to determining that the given timer entry corresponds to a timer expiration, transmitting a function pointer to a processor scheduler and transmitting a function argument to the processor scheduler.

8. The method of claim 6, further comprising:
in response to determining that the given timer entry corresponds to a timer expiration, and in response to determining that the given timer entry is identified as a periodic timer entry, modifying the first value.

9. The method of claim 6, further comprising:
in response to determining that the given timer entry corresponds to a timer expiration, transmitting a function pointer to a processor scheduler and transmitting a function argument to the processor scheduler using either a first buffer or a second buffer based on whether the given timer entry is indicated as being a real time (RT) timer entry or a non-real time (non-RT) timer entry.

10. The method of claim 1 further comprising:
receiving data via a memory managed register (MMR) from an application processor core, wherein the data indicates a plurality of values of a new timer entry; and
storing the new timer entry to a memory, in a range of addresses associated with the first group of timer entries, wherein the new timer entry includes values based on the data.

11. The method of claim 1 further comprising:
receiving data via a memory managed register (MMR) from an application processor core, wherein the data indicates an index of an existing timer entry, of the first group of timer entries, to be deleted;
storing a second value in the existing timer entry, wherein the second value indicates that the existing timer entry is free.

12. A network accelerator comprising:
a processor core;
a processor scheduler, communicatively coupled with the processor core; and
a timer manager, communicatively coupled with the processor scheduler, wherein the timer manager includes:
a memory configured to store a plurality of timer entries that includes a first group of timer entries and a second group of timer entries;
a plurality of registers configured to store first settings of a first group of the timer entries and to store second settings of a second group of the timer entries; and
hardware logic configured to determine whether the first group of timer entries corresponds to a timer expiration more often than the second group of timer entries, according to the first settings and the second settings, and further configured to communicate with the processor core via the processor scheduler in response to accessing the plurality of timer entries.

13. The network accelerator of claim 12, wherein the hardware logic is configured to determine whether a first timer entry of the first group of timer entries corresponds to a timer expiration by comparing a first value in the first timer entry to a value of a counter of the timer manager.

14. The network accelerator of claim 13, wherein the hardware logic is configured to, upon determining that the first timer entry corresponds to a timer expiration, transmit a processor function pointer and a processor function argument of the first timer entry to the processor scheduler.

15. The network accelerator of claim 13, wherein the hardware logic is configured to, upon determining that the first timer entry corresponds to a timer expiration, change the first value based at least in part upon determining that the first timer entry is a periodic timer entry.

16. A hardware timer manager comprising:
a memory configured to store a plurality of timer entries;
a plurality of registers configured to store an indication of a first precision level for a first group of the timer entries and to store an indication of a second precision level for a second group of the timer entries; and
hardware logic configured to determine whether the first group of timer entries corresponds to a timer expiration based on the first precision level and to determine whether the second group of timer entries corresponds to a timer expiration based on the second precision level, further wherein the first precision level is different from the second precision level.

17. The hardware timer manager of claim 16, wherein the indication of the first precision level includes a value defining a quantity of accesses of the first group of timer entries between each access of the second group of timer entries.

18. The hardware timer manager of claim 16, wherein the plurality of registers comprises a plurality of memory mapped registers (MMRs), wherein the MMRs are coupled with an application processor core that is configured to write the indication of the first precision level and the indication of the second precision level.

19. The hardware timer manager of claim 16, wherein the hardware logic is further configured to:
determine that a first timer entry of the first group of timer entries corresponds to a timer expiration; and
transmit a processor function pointer and a processor function argument of the first timer entry to a processor core, in response to the first timer entry corresponding to a timer expiration.

20. The hardware timer manager of claim 19, wherein the processor function argument references a packet stored in a data memory of a network accelerator, and wherein the hardware timer manager and the processor core are included in the network accelerator.
